(19) United States
(12) Patent Application Publication
(10) Pub. No.: US 2013/0294726 A1
(43) Pub. Date: Nov. 7, 2013

(54) OPTICAL MODULE HAVING ENHANCED OPTICAL COUPLING EFFICIENCY BETWEEN LASER DIODE AND OPTICAL FIBER

(71) Applicant: Takeshi Okada, Yokohama-shi (JP)

(72) Inventor: Takeshi Okada, Yokohama-shi (JP)

(73) Assignee: SUMITOMO ELECTRIC DEVICE INNOVATIONS, INC., Yokohama-shi (JP)

(21) Appl. No.: 13/979,279

(22) PCT Filed: Feb. 7, 2012
(86) PCT No.: PCT/JP2012/053205

§ 371 Date: Jul. 11, 2013

(30) Foreign Application Priority Data
Feb. 10, 2011 (JP) 2011-026988

(51) Int. Cl. G02B 6/42

(52) U.S. Cl. CPC G02B 6/4296
USPC 385/33

(57) ABSTRACT

An optical module to emit light is disclosed where the optical module enhances the coupling efficiency between an LD and the optical fiber without increasing complexity in the optical alignment. The optical module includes a first aspheric lens and a second aspheric lens, where the first lens is implemented with a cap of the module; while, the second lens is supported in the holder on the cap. The holder may align with the cap. The lens system of the optical module shows the magnification of about 4 to 7, and the NA in a side of the optical fiber is equal to or greater than 0.13, while, that in the opposite side is equal to or greater than 0.65.

### TECHNICAL FIELD

Embodiments of the present invention relate to an optical module, in particular, relate to a transmitting optical module optically coupled with an optical fiber.

### BACKGROUND ART

An optical module applicable to the optical communication system couples light emitted from a semiconductor laser diode (hereafter denoted as LD) optically with an optical fiber by concentrating the light with a lens. Because the LD emits divergent light, the coupling efficiency or other optical performances due to the spherical aberration will be degraded when a spherical lens concentrates the light from the LD. Various documents, such as Japanese Patent Application Laid-Open No. H09-061665, has disclosed a system to implement with an aspheric lens to couple the light from the LD to the optical fiber.

When a single aspheric lens concentrates divergent light from the LD, enhanced coupling efficiency may be obtained for an aspheric lens with a larger numerical aperture (NA). However, a commercially available aspheric lens limits the NA of about 0.12 for a side facing the optical fiber and about 0.6 for the other side facing the LD. An aspheric lens with further large NA is not only hard to produce but lowered in the transmission of the light entering peripheral regions of the lens where the light is totally reflected because of a large incident angle.

### SUMMARY OF INVENTION

An optical module according to an embodiment of the present invention transmits light to an optical fiber. The optical module may comprise an LD and a lens system. The LD may emit signal light. The lens system concentrates the signal light in the optical fiber, and may include a first aspheric lens and a second aspheric lens. A feature of the optical module is that the lens system has the magnification of 4 to 7, a numerical aperture (hereafter denoted as NA) equal to or greater than 0.13 for the side facing the optical fiber, while an NA equal to or greater than 0.65 for the other side facing the LD.

According to the optical module of the present invention, the optical coupling efficiency between the optical fiber and the LD may be enhanced without bringing complexity of the optical alignment therebetween and increasing the cost thereof.

### BRIEF DESCRIPTION OF DRAWINGS

The foregoing and other purposes, aspects and advantages will be better understood from the following detailed description of embodiments of the invention with reference to the drawings, in which:

FIG. 1 is a cross section of a bi-directional optical module taken along the optical axis of the optical fiber, where the bi-directional optical module implements with an optical module of the invention;

FIG. 2A compares the focal point against the incident angle of a spherical lens and an aspheric lens, FIG. 2B shows the NA of the single aspheric lens system, and FIG. 2c shows the NA of the dual aspheric lens system; and

FIG. 3A magnifies a physical relation between the stem, the cap, and the holder of the housing of the optical module according to an embodiment of the invention, and FIGS. 3B and 3C show examples of a mark denoting a direction of the major axis of the ellipsoidal field pattern of light transmitting the anamorphic and aspheric lens.

### DESCRIPTION OF EMBODIMENTS

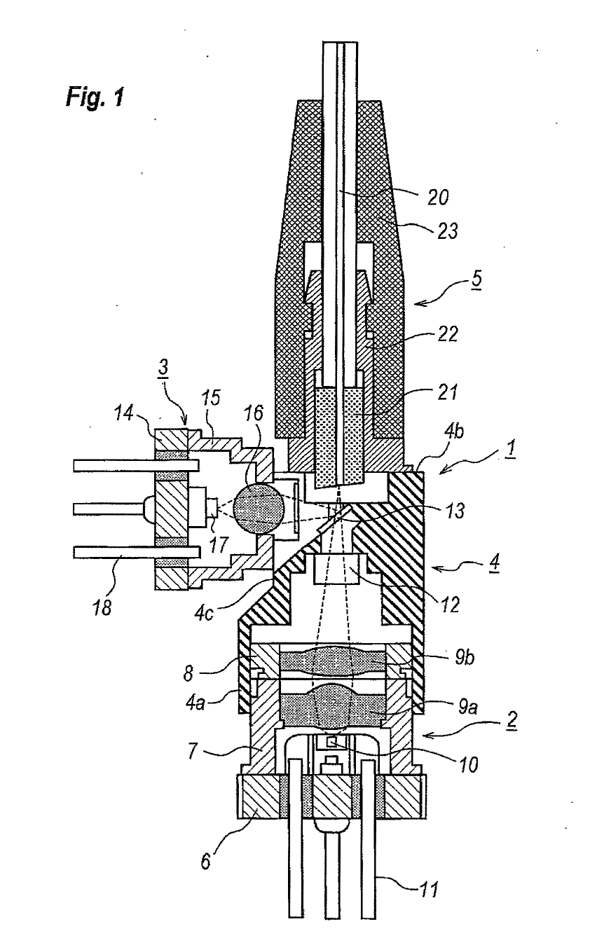

Some embodiments according to the present invention will be described as referring to drawings. FIG. 1 shows an example of an optical module to which an aspect of the present invention may be applied. The optical module shown in FIG. 1 may be a type of, what is called, a bi-directional optical module implementing with an optical transmitting unit 2 and an optical receiving unit 3. The optical module 1 may further include a housing 4 that installs an optical isolator 12 and a wavelength de-multiplexing (hereafter denoted as WDM) filter 13, a coupling unit 5 that installs a ferrule 21 attached to an end of an optical fiber 20, a sleeve 22 and a sleeve cover 23. The optical transmitting unit 2, which is assembled with the housing 4 in a position opposite to the coupling unit 5 along the optical axis of the optical fiber 20, includes a semiconductor laser diode (hereafter denoted as LD) 10, a stem 6, a cap 7, and a lens holder 8. The cap mounts a first aspheric lens 9a while the lens holder 8 mounts a second aspheric lens 9b. The first aspheric lens 9a and the second aspheric lens 9b configure a lens system having a magnification of 4 to 7. The stem 6 mounts the LD 10 and has a plurality of leads 11. The optical receiving unit 3 includes a semiconductor photodiode 17, a stem 14, and a cap 15. The cap mounts a spherical lens 16. The stem 14 mounts the PD 17 and has a plurality of leads 18 extending along a direction perpendicular to the optical axis of the fiber 20.

The optical transmitting unit 2 is assembled with the housing 4 in a direction parallel to the optical axis, while, the optical receiving unit 3 is assembled with the housing 4 in a direction perpendicular to the optical axis. Thus, the housing has a function to couple the optical transmitting unit 2 with the optical fiber 20 and the optical receiving unit 3 with the optical fiber 20.

The WDM filter 13 in the housing may pass the optical axis connecting the optical transmitting unit 2 with the optical fiber 20; while, the WDM filter 13 may bend the optical axis connecting the optical receiving unit 3 with the optical fiber 20 by substantially right angle. Specifically, the WDM filter 13 may pass the light coming from the optical transmitting unit 2, which is emitted from the LD 10, and heading to the optical fiber 20, while, it reflect the light coming from the optical fiber toward the optical receiving unit 3, namely, the PD 17 therein. The former light from the optical transmitting unit 2 has a wavelength different from the latter light from the optical fiber 20. The optical isolator 12 may pass light emitted from the optical transmitting unit 2 and heading to the optical fiber 20 but prevent light from heading to the optical transmitting unit 2.

The coupling unit 5 may couple two units, 2 and 3, optically with the optical fiber 20. Specifically, the optical fiber 20 in the end thereof is assembled with the ferrule 21, and the ferrule 21 is fixed to on one of outer surfaces 4b of the housing 4. Sliding the sleeve 22, which receives the ferrule therein, on the surface 4b before the fixation, the optical alignment may be carried out in the plane perpendicular to the optical axis of the optical fiber; while, the alignment along the optical axis may be performed by adjusting an inserting depth of the cap 7 and the holder 8 within a bore of the housing 4 for the optical transmitting unit 2. On the other hand, the optical alignment between the optical fiber 20 and the PD 17 may be realized in the plane perpendicular to the optical axis of the optical receiving unit 4 by sliding the optical receiving unit 3 on an outer surface 4c of the housing 4 before the fixation of the unit 3. Because the optical alignment of the PD along the optical axis thereof is dull enough compared to that in the plane perpendicular to the axis, the optical receiving unit 3 and the housing 4 do not provide a function to adjust the insertion depth of the cap 3 into the housing 4. Moreover, a protruding length of the tip end of the ferrule 21 into the housing 4 is also dull compared with the inserting depth of the optical transmitting unit 2 into the housing 4, the protruding length may be unnecessary to be adjusted finely.

In the optical module 1 thus configured optically, the light emitted from the LD 10 may be concentrated by the first aspheric lens 9a and the second aspheric lens 9b to couple optically with the end of the optical fiber 20 by passing the optical isolator 12 and the WDM filter 13. On the other hand, the other light output from the end of the optical fiber 20 may couple optically with the PD 17 reflected by the WDM filter 13 and then concentrated by the spherical lens 16.

A feature of the optical module 1 according to the present embodiment is that the optical module 1 provides two aspheric lenses in the optical transmitting unit 2 to concentrate light emitted from the LD 10 on the end of the optical fiber 20. The first lens 9a, as described above, is set in the cap 7, while, the second lens 9b is held in the holder 8. This arrangement for two lenses, 9a and 9b, may make it possible to align the second lens 9b optically with the first lens 9a within the plane perpendicular to the optical axis of the transmitting unit 2.

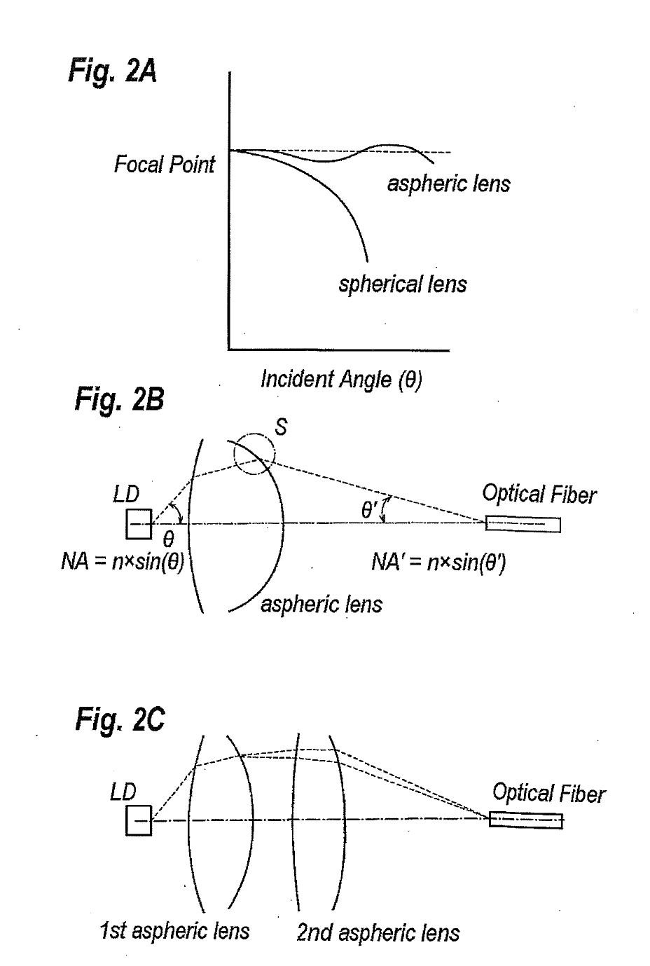

The aspheric lens exhibits an advantage shown in FIG. 2A; that is, although a spherical lens inherently shows dependence of the focal point on the incident angle of the light entering the lens, which causes the spherical aberration to degrade the optical coupling efficiency, the aspheric lens may keep the focal point within a limited deviation to cancel the spherical aberration. Because the LD 10 emits divergent light, which means that the light entering the lens has a wide range of the incident angle, the aspheric lens may effectively concentrate such light on the end of the optical fiber.

It is further preferable that, when a aspheric lens couples the light coming from the LD 10 on the optical fiber, the numerical aperture (hereafter denoted as NA) is set greater to enhance the coupling efficiency. The NA may be denoted as:

NA=n×sin(θ),

for the LD 10 as shown in FIG. 2B, where n is the refractive index of the medium, in particular, n=1 for air, and θ is the divergent angle of the light emitted from the LD 10. Similarly, the NA′ for the optical fiber 20 is given by:

NA′=n×sin(θ′),

where θ′ is the divergent angle of the light entering the optical fiber 20.

The molding may generally produce the aspheric lens described above. However, when only one aspheric lens produced by the molding is applied to the optical transmitting unit 2, a peripheral region shown in S having a larger gradient is necessary to be processed precisely, which results in a condition that an aspheric lens with a large NA becomes cost ineffective. The upper most NA at the side facing the LD 10 is practically limited to be about 0.6, while, the NA at the side facing the optical fiber 20 is limited to be about 0.12.

The optical module of the present embodiment, as shown in FIG. 2C, divides the aspheric lens into two parts, the first lens 9a and the second lens 9b, to solve the subject above described. The dual lens system facilitates the design of the lens, specifically, the gradient in the peripheral region S becomes moderate, and makes it possible to set the NA at the side facing the LD 10 to be equal to or greater than 0.65 and the NA at the side facing the optical fiber 20 to be equal to or greater than 0.13.

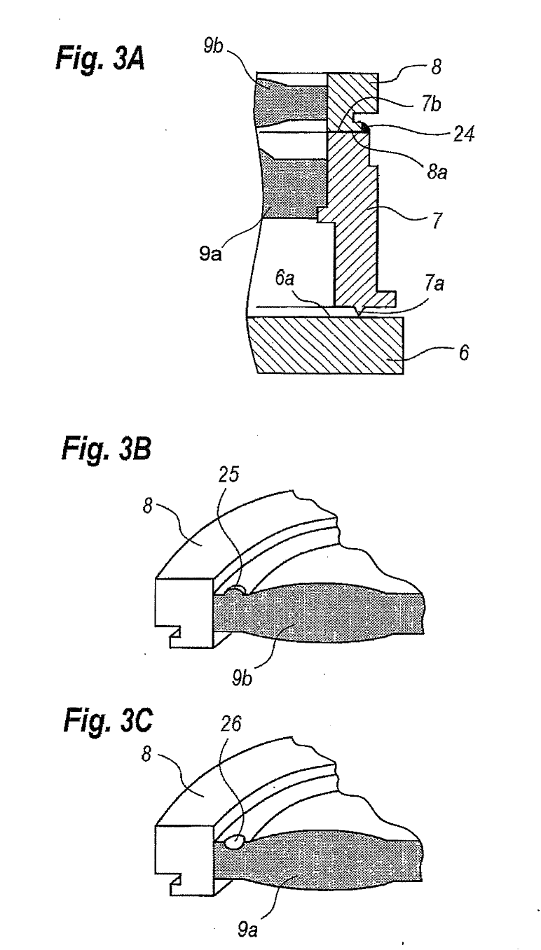

FIG. 3A magnifies a portion where the cap 7 to support the first lens 9a and the holder 8 to support the second lens 9b are assembled each other and with the stem 6. The cap 7 may be welded with the top surface 6a of the stem 6 by the resistance welding as crashing the projection 7a formed in the bottom of the cap 7. In one embodiment, the cap 7 may has a thick sidewall to show enough tolerance against physical deformation by the welding. Specifically, the sidewall of the cap 7 has a width about ten times thicker than a width of the projection 7a. A conventional optical module generally has a sidewall whose thickness is only about three times larger than the width of the projection. A thicker sidewall also increases the heat capacity thereof, which means that only the projection is crashed by the resistance welding and a scattering of the height of the cap 7 after the welding may be suppressed.

The second aspheric lens 9b is held by the holder 8 to secure a gap against the first aspheric lens 9a. The top surface 7b of the cap 7 and the bottom surface 9a of the holder 8 that faces the top surface 7b are processed in substantially flat and in perpendicular to the optical axis of the aspheric lenses, 9a and 9b. Accordingly, only the welding of the holder 8 with the cap 7, which may be carried out by the fillet welding for the flange 8b of the holder 8 using the YAG laser beams, may automatically determine the distance between the aspheric lenses, 9a and 9b. Moreover, because the distance between the lenses is thus determined, only the optical alignment of the second lens 9b against the first lens 9a may be performed by sliding the holder 8 on the top surface 7b of the cap 7. After the optical alignment of the holder 8, the holder 8 is fixed to the cap 7.

The end of the optical fiber 20 is generally processed to make an angle of around 7° with respect to the optical axis thereof to prevent light reflected thereat from returning the LD 10. The light coming from the LD 10 may therefore make a substantial incident angle not a right angle against the end surface of the optical fiber 10 in order to enhance the optical coupling efficiency. That is, the incident angle of the light entering the optical fiber 20 may make a substantial angle of several degrees with respect to the axis of the optical fiber 20. The optical module 1 according to the present embodiment may set the incident angle of the light passing two aspheric lenses, 9a and 9b, and entering the inclined end surface of the optical fiber 20 by offsetting the center of the second lens 9b with respect to the center of the first lens 9a. The process to offset the centers may be simply but precisely carried out by sliding the holder 8 on the top 7b of the cap 7.

Moreover, a conventional LD 10 generally shows a warped or an ellipsoidal field pattern, that is, an LD with an arrangement of, what is called, the edge-emitting type, generally shows the ellipsoidal filed pattern where the field pattern is extended along a direction parallel to the layer extension of the semiconductor material. In one embodiment, compensation to correct the ellipsoidal field pattern to a circular one may be implemented to couple the light emitted from the LD 10 optically with the optical fiber 20 in good coupling efficiency, because the optical fiber has a circular core.

In one embodiment, at least one of the aspheric lenses, 9a or 9b, may be a type of, what is called, an anamorphic lens to convert the ellipsoidal field pattern into the circular pattern in addition to provide the function to suppress the spherical aberration. The anamorphic lens has a magnification ratio along a direction different from a magnification ratio along another direction perpendicular to the former one. In one embodiment, the second aspheric lens 9b may have the type of the anamorphic lens because the second aspheric lens 9b requires more procedures to align the rotation around the optical axis.

In one embodiment, a mark put on the major axis of the ellipsoid of the anamorphic lens may easily distinguish the direction of the lens. FIGS. 3B and 3C show examples of the mark put in the second aspheric lens 9b. A projection 25 in FIG. 3B, or a hollow 26 in FIG. 3C, which is put on the periphery of the lens 9b and on the major axis of the ellipsoid may be a mark to distinguish the direction of the lens 9b. A frosted area in the periphery of the lens on the major axis may be an alternative of the mark described above. Rotating around the axis and sliding the holder 8 on the top surface 7b of the cap 7, the optical alignment between two lenses, 9a and 9b, and aligning the angle of the anamorphic lens 9b may be carried out.

The optical module described with reference to specific exemplary embodiments thereof may enhance the effective NA for the lens system having the magnification of 4 to 7, which is adequate for coupling the LD optical with the optical fiber by implementing dual aspheric lenses between the LD and the optical fiber. These dual lenses are held by respective members, the cap and the holder. Offsetting the center of one of the lenses from the other of the lenses by sliding the holder on the cap, the optical alignment of the LD with respect to the fiber may be enhanced even when the end surface of the optical fiber is inclined with respect to the axis of the optical fiber. Moreover, setting the second lens held by the holder to be an anamorphic lens and preparing a mark denoting a direction of an axis of the ellipsoid of the anamorphic lens, the angle of the anamorphic and aspheric lens may be easily set by rotating the holder on the cap.

In the foregoing detailed description, the optical module of the present invention has been described with reference to specific exemplary embodiments thereof. However, it will be evident that various modifications and changes may be made thereto without departing from the broader spirit and scope of the present invention. The present specification and figures are accordingly to be regarded as illustrative rather than restrictive.

1. An optical module for transmitting light to an optical fiber, comprising:
a semiconductor laser diode to emit signal light; and
a lens system to concentrate the signal light in the optical fiber, the lens system having a first aspheric lens and a second aspheric lens,
wherein the lens system has a magnification of 4 to 7, a numerical aperture equal to or greater than 0.13 in a side facing the optical fiber, and a numerical aperture equal to or greater than 0.65 in another side facing the semiconductor laser diode.

2. The optical module of claim 1,
further comprising a package and a holder, the package installing the semiconductor laser diode therein, the holder being assembled with the package,
wherein the first aspheric lens is held in the package and the second aspheric lens is held in the holder.

3. The optical module of claim 2,
wherein the optical fiber has an end surface inclined with an axis of the optical fiber, and
wherein the first aspheric lens has an axis offset from an axis of the second aspheric lens to tilt a direction of the signal light entering at the end surface of the optical fiber.

4. The optical module of claim 2,
wherein the package further provides a stern and a cap to configure a co-axial housing, the stern mounting the semiconductor laser diode thereon, and the cap supporting the first aspheric lens and being fixed to the stern.

5. The optical module of claim 4,
wherein the cap has a top surface to assemble the holder therewith.

6. The optical module of claim 1,
wherein the lens system constitutes an anamorphic lens.

7. The optical module of claim 6,
wherein at least one of the first aspheric lens and the second aspheric lens is the anamorphic lens having a mark indicating a direction of one of a major axis and a minor axis of a field pattern of light transmitting therethrough.
